(19) United States
(12) Patent Application Publication
(10) Pub. No.: US 2023/0409150 A1
(43) Pub. Date: Dec. 21, 2023

(54) TOUCH PANEL CONDUCTIVE MEMBER AND METHOD FOR PRODUCING TOUCH PANEL CONDUCTIVE MEMBER

(71) Applicant: FUJIFILM Corporation, Tokyo (JP)

(72) Inventor: Shinya KATO, Kanagawa (JP)

(73) Assignee: FUJIFILM Corporation, Tokyo (JP)

(21) Appl. No.: 18/461,203

(22) Filed: Sep. 5, 2023

Related U.S. Application Data
(63) Continuation of application No. PCT/JP2022/006745, filed on Feb. 18, 2022.

(30) Foreign Application Priority Data
Mar. 11, 2021 (JP) 2021-039550

(51) Int. Cl. G06F 3/044

(52) U.S. Cl. CPC G06F 3/044; G06F 2203/04112; G06F 2203/04103

(57) ABSTRACT

Provided are a touch panel conductive member intended to achieve both the reduction in electrical resistance of metal thin wires and bendability, and a method for producing same. The touch panel conductive member includes a transparent insulating substrate, an undercoat layer disposed thereon, first metal thin wires disposed on the undercoat layer, and a transparent insulating layer covering the first metal thin wires. The first metal thin wires have a thickness of 350 to 1000 nm. When a sectional image of the touch panel conductive member in a direction orthogonal to a direction in which the first metal thin wires extend is taken at ten positions and one of the first metal thin wires is observed at each of the ten positions, a void between a side surface of the one of the first metal thin wires and the transparent insulating layer is observed at six or more positions.

### CROSS-REFERENCE TO RELATED APPLICATIONS

This application is a Continuation of PCT International Application No. PCT/JP2022/006745 filed on Feb. 18, 2022, which claims priority under 35 U. S.C. § 119(a) to Japanese Patent Application No. 2021-039550 filed on Mar. 11, 2021. The above applications are hereby expressly incorporated by reference, in their entirety, into the present application.

### BACKGROUND OF THE INVENTION

### 1. Field of the Invention

The present invention relates to a touch panel conductive member used in a touch panel and a method for producing a touch panel conductive member.

### 2. Description of the Related Art

In various electronic devices including portable information devices such as tablet computers and smartphones, a touch panel used to perform an input operation on the electronic devices by bringing a finger, a stylus pen, or the like into contact with or close to a screen is used in combination with a display device such as a liquid crystal display device.

The touch panel usually has a conductive member on which a plurality of detection electrodes and the like for detecting a touch operation with a finger, a stylus pen, or the like are formed. The detection electrodes are formed of a transparent conductive oxide such as indium tin oxide (ITO), a metal, or the like. As compared with the transparent conductive oxide, the metal has advantages such as easy patterning, excellent flexibility, and lower electrical resistance. Therefore, in the touch panel, a metal such as copper or silver is used for conductive thin wires constituting the detection electrodes.

For example, JP2016-06562A discloses a transparent conductive film for touch panels obtained by preparing a conductive laminated body for touch panel sensors in which a transparent plastic film substrate, a light-colored layer having a thickness of 1 to 50 nm, a copper conductive layer, and a positive photosensitive layer having a dry thickness of 0.5 to 5 μm are laminated in this order and by processing the conductive layer into mesh-like electrode wiring lines having a line width of 1 to 10 μm by a photolithography method including pattern-exposing, developing, and etching steps.

### SUMMARY OF THE INVENTION

In recent years, there has been a demand for a touch panel in which the resistance of a conductive layer is further reduced to improve touch operability. In the case where metal thin wires are used for detection electrodes, when the thickness of the metal thin wires is increased to reduce the electrical resistance of the metal thin wires, bending of the wiring portion constituted by the metal thin wires causes breaking or cracking of the metal thin wires, which deteriorates the bendability. For example, in the transparent conductive film for touch panels disclosed in JP2016-06562A, when the thickness of the mesh-like electrode wiring lines is increased to reduce the electrical resistance, the bendability is deteriorated as in the case of the above-mentioned metal thin wires.

To narrow the frame around the display for improving the design, there is a demand for bending a peripheral wiring portion of a touch panel. As described above, it is desired to achieve both the reduction in electrical resistance for improving touch operability and the bendability.

It is an object of the present invention to provide a touch panel conductive member intended to achieve both the reduction in electrical resistance of metal thin wires and the bendability, and a method for producing the touch panel conductive member.

To achieve the above object, according to an aspect of the present invention, there is provided a touch panel conductive member having a transparent insulating substrate, an undercoat layer disposed on the transparent insulating substrate, first metal thin wires disposed on the undercoat layer, and a transparent insulating layer covering the first metal thin wires. The first metal thin wires have a thickness of 350 to 1000 nm. When a sectional image of the touch panel conductive member in a direction orthogonal to a direction in which the first metal thin wires extend is taken at ten positions and one of the first metal thin wires is observed at each of the ten positions, a void between a side surface of the one of the first metal thin wires and the transparent insulating layer is observed at six or more positions.

Preferably, the first metal thin wires constitute a mesh pattern, and have a width of 1.5 to 4.0 μm.

Preferably, second metal thin wires are further disposed on the transparent insulating layer, and the transparent insulating layer has a thickness of 1.0 to 5.0 μm.

Preferably, the second metal thin wires constitute a mesh pattern, and have a width of 1.5 to 4.0 μm.

Preferably, the first metal thin wires are formed of copper, and the second metal thin wires are formed of copper.

Preferably, the transparent insulating substrate is a substrate including a polyester resin, and has a thickness of 10 to 60 μm.

According to an aspect of the present invention, there is provided a method for producing a touch panel conductive member, the method including a first step of forming an undercoat layer on a transparent insulating substrate, a second step of forming first metal thin wires on the undercoat layer, and a third step of forming a transparent insulating layer covering the first metal thin wires. The first metal thin wires have a thickness of 350 to 1000 nm. The undercoat layer includes a surfactant containing at least one of a fluorine atom or a silicon atom, and a content of the surfactant is 0.01 to 5 mass % relative to a total mass of the undercoat layer.

Preferably, the third step is a step of applying a transparent insulating layer-forming composition onto the first metal thin wires to form a transparent insulating layer.

Preferably, the second step includes a step of forming the first metal thin wires in a mesh pattern.

Preferably, the method further includes a fourth step of forming second metal thin wires on the transparent insulating layer.

Preferably, the fourth step includes a step of forming the second metal thin wires in a mesh pattern.

Preferably, the first metal thin wires are formed of copper, and the second metal thin wires are formed of copper.

The present invention can provide a touch panel conductive member intended to achieve both the reduction in electrical resistance of metal thin wires and the bendability.

### BRIEF DESCRIPTION OF THE DRAWINGS

FIG. 1 is a schematic sectional view illustrating a first example of an image display device having a touch panel conductive member according to an embodiment of the present invention;

FIG. 2 is a schematic plan view illustrating an example of a touch panel conductive member according to an embodiment of the present invention;

FIG. 3 is a schematic sectional view illustrating an example of a touch panel conductive member according to an embodiment of the present invention;

FIG. 4 is a schematic view illustrating an electrode configuration of a touch panel conductive member according to an embodiment of the present invention;

FIG. 5 is a schematic view illustrating an example of a mesh pattern shape of a touch panel conductive member according to an embodiment of the present invention;

FIG. 6 is a schematic sectional view illustrating a second example of an image display device having a touch panel conductive member according to an embodiment of the present invention; and

FIG. 7 is a schematic view illustrating a touch panel conductive member for evaluating bendability.

### DESCRIPTION OF THE PREFERRED EMBODIMENTS

Hereafter, a touch panel conductive member and a method for producing a touch panel conductive member according to the present invention will be described in detail based on preferred embodiments illustrated in the attached drawings.

The drawings used for the following description are merely examples for describing the present invention, and the present invention is not limited to the drawings mentioned hereafter.

Hereafter, numerical values before and after “to” are inclusive in the numerical range. For example, when ε is a value ε_{α} to a value ε_{β}, the range of ε is a range including the value Ca and the value ε_{β}, which is expressed by mathematical symbols as ε_{α}<ε<ε_{β}.

The angles such as “angles expressed by specific values”, “parallel”, and “orthogonal” include a margin of error generally tolerable in the corresponding technical field unless otherwise specified.

The term “transparent” means that the light transmittance is 40% or more, preferably 80% or more, and more preferably 90% or more in a visible light wavelength range of 380 to 780 nm, unless otherwise specified.

The light transmittance is measured by using “Plastics—Determination of total light transmittance and total light reflectance” specified in JIS (Japanese Industrial Standard) K 7375:2008.

The term “insulation” refers to electrical insulation unless otherwise specified. The insulating substrate is a substrate having electrical insulation, and has an electrical resistance according to the intended use. For example, when conductive wires are formed on both surfaces of the insulating substrate, the conductive wires formed on both surfaces are not electrically connected to each other.

### Image Display Device

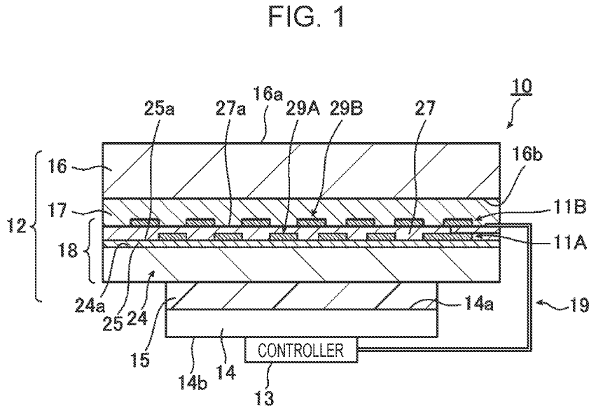

FIG. 1 is a schematic sectional view illustrating a first example of an image display device having a touch panel conductive member according to an embodiment of the present invention.

An image display device 10 of a first example illustrated in FIG. 1 has a touch panel 12 and an image display unit 14, and the touch panel 12 is stacked on a display surface 14a of the image display unit 14. The image display device 10 can detect touching to a region of an image or the like displayed on the image display unit 14.

In the image display device 10, the touch panel 12 and the image display unit 14 are stacked with a first transparent insulating layer 15 interposed therebetween. The touch panel 12 includes a cover layer 16 disposed on a touch panel conductive member 18 with a second transparent insulating layer 17 interposed therebetween. The first transparent insulating layer 15 is disposed on the entire display surface 14a of the image display unit 14. For example, when viewed from a front surface 16a of the cover layer 16, the touch panel conductive member 18 and the second transparent insulating layer 17 have the same size. When viewed from the front surface 16a of the cover layer 16, the image display unit 14 is smaller than the touch panel conductive member 18, and the image display unit 14 and the first transparent insulating layer have the same size.

In the image display device 10, the first transparent insulating layer 15, the touch panel conductive member 18, the second transparent insulating layer 17, and the cover layer 16 that are disposed on the display surface 14a of the image display unit 14 are each preferably transparent so that a display object (not illustrated) displayed on the display surface 14a of the image display unit 14 can be visually recognized.

If the cover layer 16 is formed of glass, the cover layer 16 is referred to as a cover glass.

The front surface 16a of the cover layer 16 is a touch surface of the image display device and serves as an operation surface. In the image display device 10, an input operation is performed using the front surface 16a of the cover layer 16 as an operation surface. Note that the touch surface is a surface with which a finger, a stylus pen, or the like comes into contact. The front surface 16a of the cover layer 16 serves as a viewable surface of a display object (not illustrated) displayed on the display surface 14a of the image display unit 14.

A controller 13 is disposed on a rear surface 14b of the image display unit 14. The touch panel conductive member 18 and the controller 13 are electrically connected by, for example, a flexible wiring member such as a flexible circuit board 19.

A decorative layer (not illustrated) having a light-shielding function may be disposed on the rear surface 16b of the cover layer 16. The decorative layer is, for example, disposed along the outer edge of the cover layer 16 when viewed from the front surface 16a of the cover layer 16. A region where the decorative layer is disposed is referred to as a frame portion. The decorative layer prevents, from being visually recognized, components under the frame portion, such as electrode terminals and peripheral wiring lines of the touch panel conductive member 18 described later.

The controller 13 may be a publicly known controller used for detecting contact of a finger or the like on the front surface 16a of the cover layer 16 serving as a touch surface. In the case where the touch panel 12 is a capacitive touch panel, the controller 13 detects a position at which the capacitance is changed in the touch panel conductive member 18 by contact of a finger or the like on the front surface 16a of the cover layer 16 serving as a touch surface. The capacitive touch panel includes a mutual-capacitive touch panel and a self-capacitive touch panel, but is not particularly limited thereto.

The cover layer 16 protects the touch panel conductive member 18. The configuration of the cover layer 16 is not particularly limited. The cover layer 16 is preferably transparent so that a display object (not illustrated) displayed on the display surface 14a of the image display unit 14 can be visually recognized. The cover layer 16 is formed of, for example, a glass plate, chemically strengthened glass, alkali-free glass, or the like. The thickness of the cover layer 16 is preferably selected as appropriate in accordance with the intended use. The cover layer 16 is also formed of a plastic film, a plastic plate, or the like instead of the glass plate.

Examples of the raw materials for the above-mentioned plastic film and plastic plate include polyesters such as polyethylene terephthalate (PET) and polyethylene naphthalate (PEN); polyolefin resins such as polyethylene (PE), polypropylene (PP), polystyrene, and ethylene-vinyl acetate copolymer (EVA); vinyl resins; and others materials such as polycarbonate (PC) resin, polyamide resin, polyimide resin, (meth)acrylic resin, triacetyl cellulose (TAC), cycloolefin-based resin (COP), polyvinylidene fluoride (PVDF), polyarylate (PAR), polyethersulfone (PES), fluorene derivatives, and crystalline COP.

The (meth)acrylic resin is a general term including an acrylic resin and a methacrylic resin.

The cover layer 16 may have a polarizing plate, a circularly polarizing plate, or the like.

Since the front surface 16a of the cover layer 16 serves as a touch surface as described above, a hard coat layer may be optionally disposed on the front surface 16a. The thickness of the cover layer 16 is, for example, 0.1 to 1.3 mm and particularly preferably 0.1 to 0.7 mm.

The configuration of the first transparent insulating layer 15 is not particularly limited as long as the first transparent insulating layer 15 is transparent, has electrical insulation, and can stably fix the touch panel 12 and the image display unit 14. The first transparent insulating layer 15 may be formed of, for example, an optical clear resin (OCR) such as an optical clear adhesives (OCA) or an ultraviolet (UV) curable resin. The first transparent insulating layer 15 may be partially hollow.

The touch panel 12 may be disposed above the display surface 14a of the image display unit 14 with a space therebetween without disposing the first transparent insulating layer 15. This space is also referred to as an air gap.

The configuration of the second transparent insulating layer 17 is not particularly limited as long as the second transparent insulating layer 17 is transparent, has electrical insulation, and can stably fix the touch panel conductive member 18 and the cover layer 16. The second transparent insulating layer 17 may be formed of the same material as that for the first transparent insulating layer 15.

The image display unit 14 includes a display surface 14a on which a display object such as an image is displayed, and is, for example, a liquid crystal display device. The image display unit 14 is not limited to liquid crystal display devices, and may be an organic electro-luminescence (EL) display device. The image display unit 14 may be, for example, a cathode-ray tube (CRT) display device, a vacuum fluorescent display (VFD), a plasma display panel (PDP), a surface-conduction electron-emitter display (SED), a field emission display (FED), or electronic paper instead of the above-described devices.

The image display unit 14 is appropriately used in accordance with the intended use, but is preferably in the form of a panel such as a liquid crystal display panel or an organic EL panel to reduce the thickness of the image display device 10.

### Touch Panel

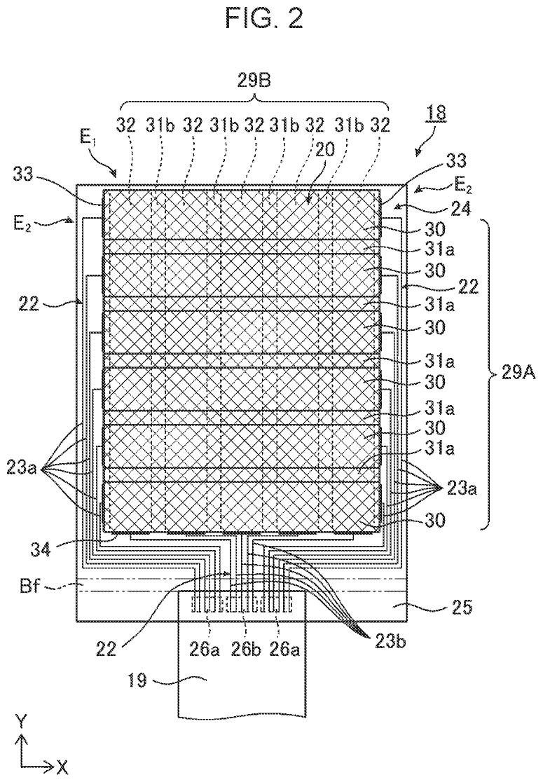

FIG. 2 is a schematic plan view illustrating an example of a touch panel conductive member according to an embodiment of the present invention. In FIG. 2, the same components as those of the image display device 10 illustrated in FIG. 1 are denoted by the same reference numerals, and the detailed description thereof will be omitted.

Hereafter, the touch panel 12 will be described with reference to FIGS. 1 and 2.

The touch panel 12 has the controller 13, the touch panel conductive member 18, and the cover layer 16. The touch panel conductive member 18 functions as a touch sensor.

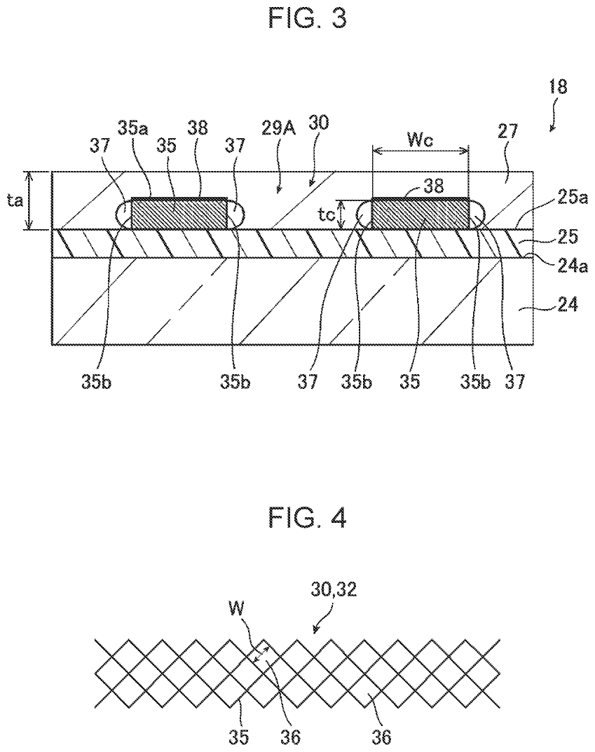

The touch panel conductive member 18 has, for example, a transparent insulating substrate 24, an undercoat layer 25 disposed on the transparent insulating substrate 24, metal thin wires 35 (see FIG. 3) disposed on the undercoat layer 25, and a transparent insulating layer 27 covering the metal thin wires 35.

A first conductive layer 11A is disposed on a front surface 25a of the undercoat layer 25. The first conductive layer 11A has a first detection electrode layer 29A having a plurality of first detection electrodes 30 and a plurality of first peripheral wiring lines 23a each having one end electrically connected to one of the first detection electrodes 30 of the first detection electrode layer 29A and the other end provided with a first external connection terminal 26a. The first conductive layer 11A is covered with the transparent insulating layer 27.

The first detection electrodes 30 are constituted by the metal thin wires 35 (see FIG. 3). The metal thin wires 35 constituting the first detection electrodes 30 are referred to as first metal thin wires. The first metal thin wires are disposed on the front surface 25a of the undercoat layer 25.

The first external connection terminals 26a are electrically connected to the flexible circuit board 19, and thus is connected to the controller 13.

Metal thin wires 35 are further disposed on the transparent insulating layer 27. Second detection electrodes 32 are constituted by the metal thin wires 35.

A second conductive layer 11B is disposed on the transparent insulating layer 27. The second conductive layer 11B has a second detection electrode layer 29B having a plurality of second detection electrodes 32 and a plurality of second peripheral wiring lines 23b each having one end electrically connected to one of the second detection electrodes 32 and the other end provided with a second external connection terminal 26b. As in the first conductive layer 11A, the second external connection terminal 26b is electrically connected to the flexible circuit board 19, and thus is connected to the controller 13.

The second detection electrodes 32 are constituted by the metal thin wires 35 (see FIG. 3). The metal thin wires 35 constituting the second detection electrodes 32 are referred to as second metal thin wires. The second metal thin wires are disposed on the transparent insulating layer 27. As described above, the metal thin wires are referred to as first metal thin wires in the first detection electrodes 30, and as second metal thin wires in the second detection electrodes 32. The first metal thin wires and the second metal thin wires are collectively referred to as metal thin wires 35. The metal thin wires 35 include the first metal thin wires and the second metal thin wires unless otherwise specified.

### Touch Panel Conductive Member

The touch panel conductive member 18 will be described with reference to FIGS. 2 and 3. FIG. 3 is a schematic sectional view illustrating an example of a touch panel conductive member according to an embodiment of the present invention. In FIG. 3, the same components as those of the image display device 10 illustrated in FIG. 1 are denoted by the same reference numerals, and the detailed description thereof will be omitted.

The touch panel conductive member 18 is a part functioning as a touch sensor of the touch panel 12, and has a detection portion 20 that is a detection region E₁ in which an input operation can be performed by a user, and a peripheral wiring portion 22 that is a peripheral region E₂ located outside the detection region E₁.

The detection portion 20 has, for example, the first detection electrode layer 29A and the second detection electrode layer 29B. The first detection electrode layer 29A and the second detection electrode layer 29B are disposed with the transparent insulating layer 27 interposed therebetween. The first detection electrode layer 29A and the second detection electrode layer 29B are electrically insulated from each other by the transparent insulating layer 27. The transparent insulating layer 27 functions as an electrical insulating layer.

As illustrated in FIG. 2, the first detection electrode layer 29A has a plurality of first detection electrodes 30 and a plurality of first dummy electrodes 31a disposed between the adjacent first detection electrodes 30 and insulated from the first detection electrodes 30.

The plurality of first detection electrodes 30 are belt-shaped electrodes extending in parallel in the X direction, and are disposed on the front surface 25a (see FIG. 1) of the undercoat layer 25 at intervals in the Y direction orthogonal to the X direction while being electrically insulated from each other in the Y direction. The plurality of first dummy electrodes 31a are arranged between the first detection electrodes 30, and disposed on the front surface 25a (see FIG. 1) of the undercoat layer 25 while being electrically insulated from the first detection electrodes 30. A first electrode terminal 33 is disposed on at least one end of each of the first detection electrodes 30 in the X direction.

The second detection electrode layer 29B has a plurality of second detection electrodes 32 and a plurality of second dummy electrodes 31b disposed between the adjacent second detection electrodes 32 and insulated from the second detection electrodes 32. The plurality of second detection electrodes 32 are belt-shaped electrodes extending in parallel in the Y direction, and are disposed on the front surface 27a (see FIG. 1) of the transparent insulating layer 27 at intervals in the X direction while being electrically insulated from each other in the X direction. The plurality of second dummy electrodes 31b are arranged between the second detection electrodes 32, and disposed on the front surface 27a (see FIG. 1) of the transparent insulating layer 27 while being electrically insulated from the second detection electrodes 32. A second electrode terminal 34 is disposed on one end of each of the second detection electrodes 32 in the Y direction.

The plurality of first detection electrodes 30 and the plurality of second detection electrodes 32 are disposed so as to be orthogonal to each other, and are electrically insulated from each other by the transparent insulating layer 27 as described above.

The first dummy electrodes 31a of the first detection electrodes 30 are separated from the first detection electrodes 30 by disconnection portions, and are regions that are not electrically connected. The second dummy electrodes 31b of the second detection electrodes 32 are separated from the second detection electrodes 32 by disconnection portions, and are regions that are not electrically connected. For this reason, as described above, the plurality of first detection electrodes 30 are electrically insulated from each other in the Y direction, and the plurality of second detection electrodes 32 are electrically insulated from each other in the X direction. As illustrated in FIG. 2, in the detection portion 20, six first detection electrodes 30 and five second detection electrodes 32 are disposed, but the number of the electrodes is not particularly limited and may be plural.

The first detection electrode layer 29A and the second detection electrode layer 29B are constituted by the metal thin wires 35 (see FIG. 3) as described above. When the first detection electrodes 30 and the second detection electrodes 32 are a metal mesh having a mesh pattern formed by the metal thin wires 35, the first dummy electrodes 31a and the second dummy electrodes 31b are also a metal mesh having a mesh pattern formed by the metal thin wires 35.

The electrode widths of the first detection electrodes 30 and the second detection electrodes 32 are, for example, 1 to 5 mm, and the pitch between the electrodes is 3 to 6 mm. The electrode width of the first detection electrodes 30 is the maximum length in the Y direction, and the electrode width of the second detection electrodes 32 is the maximum length in the X direction.

The peripheral wiring portion 22 is a region in which peripheral wiring lines (first peripheral wiring lines 23a and second peripheral wiring lines 23b) for transmitting or transferring touch drive signals and touch detection signals from the controller 13 to the first detection electrodes 30 and the second detection electrodes 32 are arranged. The peripheral wiring portion 22 has a plurality of first peripheral wiring lines 23a and a plurality of second peripheral wiring lines 23b. The first peripheral wiring lines 23a each have one end electrically connected to the corresponding one of the first detection electrodes 30 via the first electrode terminal 33, and the other end electrically connected to the first external connection terminal 26a. The second peripheral wiring lines 23b each have one end electrically connected to the corresponding one of the second detection electrodes 32 via the second electrode terminal 34, and the other end electrically connected to the second external connection terminal 26b.

The first electrode terminal 33 and the second electrode terminal 34 may have a solid film shape or a mesh shape disclosed in JP2013-127658A. The width of each of the first electrode terminal 33 and the second electrode terminal 34 is preferably in the range of 1/3 times or more and 1.2 times or less the electrode width of each of the first detection electrodes 30 and the second detection electrodes 32.

The first detection electrodes 30, the first dummy electrodes 31a, the first electrode terminals 33, and the first peripheral wiring lines 23a of the first conductive layer 11A are preferably formed in an integral manner and more preferably formed of the same metal material from the viewpoint of electrical resistance, resistance to disconnection, and the like. In this case, the first conductive layer 11A is formed by, for example, a lithography method.

Similarly, the second detection electrodes 32, the second dummy electrodes 31b, the second electrode terminals 34, and the second peripheral wiring lines 23b of the second conductive layer 11B are preferably formed in an integral manner and more preferably formed of the same metal material from the viewpoint of electrical resistance, resistance to disconnection, and the like. In this case, the second conductive layer 11B is formed by, for example, a lithography method.

FIG. 3 illustrates the touch panel conductive member 18, but a part of the touch panel conductive member 18 is omitted. FIG. 3 illustrates the transparent insulating substrate 24, the undercoat layer 25, the metal thin wires 35 of the first detection electrodes 30 of the first detection electrodes layer 29A, and the transparent insulating layer 27. The metal thin wires 35 illustrated in FIG. 3 are first metal thin wires.

For the touch panel conductive member 18, when a sectional image of the touch panel conductive member 18 in a direction orthogonal to the direction in which the metal thin wires 35 extend are taken at ten positions and one of the metal thin wires 35 is observed at each of the ten positions, a void 37 between the side surface 35b of the one of the metal thin wires 35 and the transparent insulating layer 27 is observed at 6 or more positions. That is, when the sections of ten metal thin wires 35 are observed, a void 37 is present at six or more positions among 20 of the side surfaces 35b in total. When the void 37 is present at 6 or more positions, breaking or cracking in metal thin wires 35 having a large thickness is suppressed upon bending the metal thin wires 35, which improves the bendability.

For example, the touch panel conductive member 18 is bent along a bending region Bf in the peripheral wiring portion 22 illustrated in FIG. 2 such that the first external connection terminals 26a and the second external connection terminal 26b face outward in order to narrow the frame around the display for improving the design. The flexible circuit board 19 electrically connected to the first external connection terminals 26a and the second external connection terminal 26b is disposed on the side of a rear surface 14b opposite to the display surface 14a of the image display unit 14.

Portions of the first peripheral wiring lines 23a present in the bending region Bf preferably have voids (not illustrated) between the side surfaces (not illustrated) and the transparent insulating layer 27. The voids of the first peripheral wiring lines 23a are the same as the voids 37 of the metal thin wires 35 illustrated in FIG. 3. Note that the first peripheral wiring lines 23a and the second peripheral wiring lines 23b can be constituted by the metal thin wires 35 as described later.

The number of the voids 37 is preferably 8 or more and more preferably 10 or more from the viewpoint of achieving a better balance between the reduction in the electrical resistance of the metal thin wires and the bendability. The upper limit of the number is not particularly limited, and may be 20.

Although the sectional image is taken in a direction orthogonal to the direction in which the metal thin wires 35 extend, the metal thin wires 35 may extend in different directions when a mesh pattern is formed by the metal thin wires 35. Even when the metal thin wires 35 extend in different directions, the sectional image is taken for the metal thin wires 35 in a direction orthogonal to the directions in which the metal thin wires 35 extend. By forming the metal thin wires 35 in a mesh pattern, the voids 37 are easily formed in the vicinity of the vertexes of the mesh cells.

The void percentage, which is a percentage of voids, is preferably 10% to 80%, more preferably 30% to 70%, and further preferably 40% to 70%. Herein, the void percentage can be obtained by observing sections of 10 metal thin wires using a scanning electron microscope (SEM) to determine whether or not a void is present at each side surface, that is, at 20 side surfaces in total. In other words, the percentage calculated from the number of voids present at the 20 side surfaces is defined as a void percentage.

It is sufficient that the voids 37 are present in the sectional image. The voids 37 are not necessarily present in the direction in which the side surfaces 35b of the metal thin wires 35 extend. Therefore, the voids 37 may be present continuously or discontinuously in the direction in which the side surfaces 35b of the metal thin wires 35 extend.

The sectional image of the touch panel conductive member 18 can be taken by using, for example, a scanning electron microscope (SEM).

Herein, the voids 37 have a size of 50% or more of the thickness tc of the metal thin wires 35. The voids 37 are present, on the transparent insulating substrate 24 side, at the interface of the metal thin wires 35 with the transparent insulating layer 27. Furthermore, the voids 37 are in contact with the undercoat layer 25 and the side surfaces 35b of the metal thin wires 35. The shape of the voids 37 is not particularly limited as long as the above-described conditions are satisfied.

The thickness tc of the metal thin wires 35 is 350 to 1000 nm and preferably 600 to 900 nm. When the thickness tc of the metal thin wires 35 is 350 to 1000 nm, the electrical resistance of the metal thin wires 35 is low. When the thickness tc of the metal thin wires 35 is 600 to 900 nm, the electrical resistance of the metal thin wires 35 is further reduced, which is more preferable. When the thickness tc of the metal thin wires 35 is large, the number of voids increases, which improves the bendability. Therefore, the thickness tc of the metal thin wires 35 is preferably large.

The width Wc of the metal thin wires 35 is preferably 1.5 to 4.0 more preferably 1.5 to 3.0 and further preferably 1.5 to 2.5 When the width Wc of the metal thin wires 35 is 1.5 to 4.0 the metal thin wires 35 are less likely to be visually recognized, and the occurrence of moire or the like is also suppressed. That is, the visibility is excellent. When the width Wc of the metal thin wires 35 is small, the number of voids increases, which improves the bendability. Therefore, the width Wc of the metal thin wires 35 is preferably small.

As will be described later, for example, a mesh pattern (see FIG. 4) is formed by the metal thin wires 35, and the metal thin wires 35 are arranged in a mesh pattern (see FIG. 4). The thickness tc of the metal thin wires 35 and the width Wc of the metal thin wires 35 are measured by cutting the touch panel conductive member 18 and taking a sectional image of the cut section using a scanning electron microscope (SEM). In the sectional image, lengths corresponding to the thickness tc and the width Wc of the metal thin wires 35 are measured at 10 positions in an image region corresponding to the metal thin wires 35, and the average of the measured values at the 10 positions is determined. Each of the thickness tc and the width Wc of the metal thin wires 35 is an average of the measured values at the above-described 10 positions.

Herein, for touch panels mounted on tablets or notebook personal computers (PCs) having a larger size than smartphones, the metal thin wires 35 need to have a lower thin wire resistance as an electrical resistance to detect a touch operation by contact or proximity of a finger, a stylus pen, or the like.

To prevent a delay in operation with a finger, a stylus pen, or the like, the thin wire resistance is preferably 80 Ω/mm or less, more preferably 60 Ω/mm, and particularly preferably Ω/mm.

The thin wire resistance of the metal thin wires described above is determined by measuring the electrical resistance of the metal thin wires and normalizing the measured value to an electrical resistance per 1 mm length (Ω/mm). The electrical resistance can be measured with, for example, an ohmmeter (RM3544 manufactured by HIOKI E. E. Corporation).

To reduce the reflectance of the metal thin wires 35, the front surfaces 35a of the metal thin wires 35 may be subjected to blackening treatment such as sulfuration or oxidation to dispose blackened layers 38. For example, each of the blackened layers 38 reduces the reflectance of the metal thin wire 35. The blackened layer 38 can be formed of copper nitride, copper oxide, copper oxynitride, molybdenum oxide, AgO, Pd, carbon, or other nitrides or oxides. The blackened layer 38 is disposed on the visible side of the metal thin wire, that is, on the front surface 35a of the metal thin wire 35 opposite to the undercoat layer 25. The blackened layer 38 is not necessarily disposed.

An adhesion layer (not illustrated) may be disposed at an interface between the metal thin wires 35 and the undercoat layer 25. For example, when the metal thin wires 35 are formed of copper, the adhesion layer is formed of copper oxide. By disposing the adhesion layer, the adhesiveness between the metal thin wires 35 and the undercoat layer 25 is improved, which can stably dispose the metal thin wires 35 on the undercoat layer 25.

The thickness ta of the transparent insulating layer 27 is preferably 1.0 to 5.0 When the thickness ta of the transparent insulating layer 27 is 1.0 to 5.0 both the insulating property and the bendability can be achieved. The thickness ta of the transparent insulating layer 27 is more preferably 2 to 5 μm and further preferably 2.5 to 4.5 μm.

The thickness ta of the transparent insulating layer 27 is measured by cutting the touch panel conductive member 18 and taking a sectional image of the cut section using a scanning electron microscope (SEM). In the sectional image, a length corresponding to the thickness of the transparent insulating layer is measured at 10 positions in an image region corresponding to the transparent insulating layer, and the average of the measured values at the 10 positions is determined. The thickness ta of the transparent insulating layer is an average of the measured values at the above-described 10 positions.

Hereafter, each component of the touch panel conductive member and the touch panel will be described.

### Transparent Insulating Substrate

The transparent insulating substrate supports metal thin wires, and supports first detection electrodes and second detection electrodes constituted by the metal thin wires. The transparent insulating substrate also supports first peripheral wiring lines and second peripheral wiring lines. When the transparent insulating substrate has one surface on which the first detection electrodes are disposed and the other surface on which the second detection electrodes are disposed, the first detection electrodes and the second detection electrodes are electrically insulated from each other. The transparent insulating substrate preferably has a thickness of 10 to 60 μm.

Examples of the material for the transparent insulating substrate include a transparent resin material and a transparent inorganic material.

Specific examples of the transparent resin material include acetyl cellulose resins such as triacetyl cellulose; polyester resins such as polyethylene terephthalate (PET) and polyethylene naphthalate (PEN); olefin resins such as polyethylene (PE), polymethylpentene, cycloolefin polymer (COP), and cycloolefin copolymer (COC); (meth)acrylic resins such as polymethyl methacrylate; and polyurethane resins, polyethersulfone, polycarbonate, polysulfone, polyether, polyether ketone, acrylonitrile, and methacrylonitrile. PET is preferable from the viewpoint of good adhesiveness to the first detection electrodes, the second detection electrodes, the first peripheral wiring lines, and the second peripheral wiring lines.

Specific examples of the transparent inorganic material include glasses such as alkali-free glass, alkali glass, chemically strengthened glass, soda glass, potash glass, and lead glass; ceramics such as translucent piezoelectric ceramics (PLZT (lead lanthanum zirconate titanate)); quartz; fluorspar; and sapphire.

The transparent insulating substrate is preferably a substrate containing a polyester resin.

The total light transmittance of the transparent insulating substrate is preferably 40 to 100% and more preferably 85 to 100%. The total light transmittance is measured by using “Plastics—Determination of total light transmittance and total light reflectance” specified in JIS K 7375:2008.

### Undercoat Layer

The undercoat layer further improves the adhesiveness of the first detection electrodes, the second detection electrodes, the first peripheral wiring lines, and the second peripheral wiring lines. The undercoat layer includes a surfactant containing at least one of a fluorine atom or a silicon atom. The content of the surfactant in the undercoat layer is 0.01 to 5 mass % and preferably 0.04 to 1.50 mass % relative to the total mass of the undercoat layer.

When the content of the surfactant in the undercoat layer is 0.01 to 5 mass % relative to the total mass of the undercoat layer, the void 37 can be disposed at six or more positions among of the side surfaces 35b in total when the sections of ten metal thin wires 35 are observed as described above.

When the transparent insulating layer covering the metal thin wires formed on the undercoat layer containing the surfactant is formed, the mechanism of the formation of the voids on the side surfaces of the metal thin wires is not clear, but the following factors are assumed. The voids are assumed to be formed because the undercoat layer containing the surfactant has a low surface free energy, and the transparent insulating layer is fixed while the wetting and spreading of the transparent insulating layer to an interface between the undercoat layer and the metal thin wires are insufficient when the transparent insulating layer is formed.

### Surfactant

The type of surfactant is not particularly limited, and a publicly known surfactant can be used. Specifically, the surfactant is preferably at least one selected from the group consisting of a silicone-based surfactant and a fluorine-based surfactant.

The surfactant is preferably an oligomer or a polymer rather than a low-molecular-weight compound.

When the surfactant is added, the surfactant immediately moves to the surface of a coating film and is unevenly distributed. The surfactant is unevenly distributed on the surface as it is even after the coating film is dried. Therefore, the surface energy of the film to which the surfactant has been added is decreased by the surfactant. From the viewpoint of preventing non-uniformity in film thickness, cissing, and unevenness, the surface energy of the film is preferably low.

Preferred examples of the silicone-based surfactant include polymers or oligomers containing a plurality of dimethylsilyloxy units as repeating units and having a substituent at a terminal and/or a side chain thereof. The polymer or oligomer containing dimethylsilyloxy as a repeating unit may contain a repeating unit other than dimethylsilyloxy. The substituents may be the same or different, and a plurality of substituents is preferably present. Preferred examples of the substituents include a polyether group, an alkyl group, an aryl group, an aryloxy group, a cinnamoyl group, an oxetanyl group, a fluoroalkyl group, and a polyoxyalkylene group.

The number-average molecular weight of the silicone-based surfactant is not particularly limited, but is preferably 100,000 or less, more preferably 50,000 or less, further preferably 1,000 to 30,000, and particularly preferably 1,000 to 20,000.

Preferred examples of the silicone-based surfactant include commercially available silicone-based surfactants having no ionizing radiation-curable group, such as X22-3710, X22-162C, X22-3701E, X22160AS, X22170DX, X224015, X22176DX, X22-176F, X224272, KF8001, and X22-2000 manufactured by Shin-Etsu Chemical Co., Ltd.; FM4421, FM0425, FMDA26, and FS1265 manufactured by Chisso Corporation; BY16-750, BY16880, BY16848, SF8427, SF8421, SH3746, SH8400, SF3771, SH3749, SH3748, and SH8410 manufactured by Dow Corning Toray Co., Ltd.; and TSF series (e.g., TSF4460, TSF4440, TSF4445, TSF4450, TSF4446, TSF4453, TSF4452, TSF4730, and TSF4770), FGF502, and SILWET series (SILWET L77, SILWET L2780, SILWET L7608, SILWET L7001, SILWET L7002, SILWET L7087, SILWET L7200, SILWET L7210, SILWET L7220, SILWET L7230, SILWET L7500, SILWET L7510, SILWET L7600, SILWET L7602, SILWET L7604, SILWET L7605, SILWET L7607, SILWET L7622, SILWET L7644, SILWET L7650, SILWET L7657, SILWET L8500, SILWET L8600, SILWET L8610, SILWET L8620, SILWET L720) manufactured by Momentive Performance Materials Japan.

Examples of the silicone-based surfactants having an ionizing radiation-curable group include X22-163A, X22-173DX, X22-163C, KF101, X22164A, X24-8201, X22174DX, X22164C, X222426, X222445, X222457, X222459, X22245, X221602, X221603, X22164E, X22164B, X22164C, X22164D, and TM0701 manufactured by Shin-Etsu Chemical Co., Ltd.; Silaplane series (e.g., FM0725, FM0721, FM7725, FM7721, FM7726, and FM7727) manufactured by Chisso Corporation; SF8411, SF8413, BY16-152D, BY16-152, BY16-152C, and 8388A manufactured by Dow Corning Toray Co., Ltd.; TEGORad 2010, 2011, 2100, 2200N, 2300, 2500, 2600, and 2700 manufactured by Evonik Degussa Japan Co., Ltd.; BYK3500 manufactured by BYK JAPAN KK; KNS5300 manufactured by Shin-Etsu Silicone; and UVHC1105 and UVHC8550 manufactured by Momentive Performance Materials Japan.

The fluorine-based surfactant is preferably a compound having, in the same molecule, a fluoroaliphatic group and a lyophilic group that contributes to affinity for various compositions for coating, molding materials, and the like when the surfactant is used as an additive. Such a compound can be generally obtained by copolymerizing a monomer having a fluoroaliphatic group and a monomer having a lyophilic group.

Typical examples of the monomer having a lyophilic group to be copolymerized with the monomer having a fluoroaliphatic group include poly(oxyalkylene) acrylate and poly(oxyalkylene) methacrylate.

Preferred examples of commercially available fluorine-based surfactants having no ionizing radiation-curable group include MEGAFACE series manufactured by DIC Corporation (e.g., MCF350-5, F472, F476, F445, F444, F443, F178, F470, F475, F479, F477, F482, F486, TF1025, F478, F178K, and F-784-F); and Ftergent series manufactured by Neos Company Limited (e.g., FTX 218, 250, 245M, 209F, 222F, 245F, 208G, 218G, 240G, 206D, and 240D). Preferred examples of commercially available fluorine-based surfactants having an ionizing radiation-curable group include Optool DAC manufactured by DAIKIN INDUSTRIES, Ltd.; and DEFENSA series (e.g., TF3001, TF3000, TF3004, TF3028, TF3027, TF3026, and TF3025) and RS series (e.g., RS71, RS101, RS102, RS103, RS104, RS105, and RS-56) manufactured by DIC Corporation.

From the viewpoint of remaining on the surface of the undercoat layer, a surfactant having an ionizing radiation-curable group is preferable.

The undercoat layer may contain a material other than the above-described surfactant.

The undercoat layer may contain a resin (binder resin). The resin functions as a binder of the undercoat layer.

The type of resin is not particularly limited, and a publicly known resin can be used. Examples of the resin include a polyester resin, a polyether resin, a (meth)acrylic resin, an epoxy resin, a urethane resin, an alkyd resin, a spiroacetal resin, a polybutadiene resin, and a polythiol polyene resin. A (meth)acrylic resin is preferable.

The content of the resin in the undercoat layer is not particularly limited, but is preferably to 95 mass %, more preferably 50 to 90 mass %, and further preferably 50 to 80 mass % relative to the total mass of the undercoat layer.

The undercoat layer may further contain inorganic particles. The type of inorganic particles is not particularly limited. The inorganic particles contain at least one selected from the group consisting of silica, titanium oxide, zirconium oxide, and aluminum oxide.

The particle size of the inorganic particles is not particularly limited, but is preferably 5 to 100 nm and more preferably 10 to 80 nm.

The content of the inorganic particles in the undercoat layer is not particularly limited, but is preferably 5 to 60 mass %, more preferably 10 to 50 mass %, and further preferably 10 to mass % relative to the total mass of the undercoat layer.

The method for forming an undercoat layer is not particularly limited, but is, for example, a method for applying an undercoat layer-forming composition as described later.

The undercoat layer-forming composition contains the above-described surfactant. The content of the surfactant is adjusted so that the content of the surfactant in the undercoat layer is within the above range.

The undercoat layer-forming composition may contain a material other than the surfactant.

Examples of the material include the above-described resin and inorganic particles.

The material is also, for example, a solvent. Examples of the solvent include water and organic solvents.

The undercoat layer-forming composition may also contain a monomer. The undercoat layer can be formed by applying an undercoat layer-forming composition containing a monomer and subjecting the resulting coating film to a curing treatment (e.g., a light irradiation treatment and a heating treatment).

The undercoat layer-forming composition may further contain a polymerization initiator. Examples of the polymerization initiator include publicly known photopolymerization initiators and thermal polymerization initiators.

The type of monomer is not particularly limited, and a monomer capable of constituting the above-described resin is selected.

In particular, the monomer is preferably a compound having a photopolymerizable functional group.

Examples of the photopolymerizable functional group include polymerizable unsaturated groups (carbon-carbon unsaturated double bond groups) such as a (meth)acryloyl group, a vinyl group, a styryl group, and an allyl group. In particular, a (meth)acryloyl group is preferable.

Specific examples of the compound having a polymerizable unsaturated group include (meth)acrylic acid diesters of alkylene glycol, such as neopentyl glycol acrylate, 1,6-hexanediol (meth)acrylate, and propylene glycol di(meth)acrylate;

(meth)acrylic acid diesters of polyoxyalkylene glycol, such as triethylene glycol di(meth)acrylate, dipropylene glycol di(meth)acrylate, polyethylene glycol di(meth)acrylate, and polypropylene glycol di(meth)acrylate;

(meth)acrylic acid diesters of polyhydric alcohols, such as pentaerythritol di(meth)acrylate; and (meth)acrylic acid diesters of ethylene oxide adducts or propylene oxide adducts, such as 2,2-bis{4-(acryloxydiethoxy)phenyl}propane and 2,2-bis{4-(acryloxypolypropoxy)phenyl}propane.

The compound having a photopolymerizable functional group is also preferably an epoxy (meth)acrylate, a urethane (meth)acrylate, or a polyester (meth)acrylate.

In particular, esters of polyhydric alcohol and (meth)acrylic acid are preferable. More preferably, at least one polyfunctional monomer having three or more (meth)acryloyl groups in one molecule is contained.

Examples thereof include pentaerythritol tetra(meth)acrylate, pentaerythritol tri(meth)acrylate, trimethylolpropane tri(meth)acrylate, EO (ethylene oxide)-modified trimethylolpropane tri(meth)acrylate, PO (propylene oxide)-modified trimethylolpropane tri(meth)acrylate, EO-modified phosphoric tri(meth)acrylate, trim ethylol ethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, caprolactone-modified dipentaerythritol hexa(meth)acrylate, 1,2,3-cyclohexane tetramethacrylate, polyurethane polyacrylate, polyester polyacrylate, and caprolactone-modified tris(acryloxyethyl) isocyanurate.

Specific examples of the polyfunctional acrylate compounds having a (meth)acryloyl group include esters of polyols and (meth)acrylic acids, such as KAYARAD DPHA, DPHA-2C, PET-30, TMPTA, TPA-320, TPA-330, RP-1040, T-1420, D-310, DPCA-20, DPCA-30, DPCA- and GPO-303 manufactured by Nippon Kayaku Co., Ltd.; and V #3PA, V #400, V #36095D, V #1000, and V #1080 manufactured by Osaka Organic Chemical Industry Ltd. Other suitable examples thereof include urethane acrylate compounds having three or more functional groups, such as SHIKOH UV-1400B, UV-1700B, UV-6300B, UV-7550B, UV-7600B, UV-7605B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, and UV-2750B (manufactured by The Nippon Synthetic Chemical Industry Co., Ltd.), UA-306H, UA-306I, UA-306T, and UL-503LN (manufactured by Kyoeisha Chemical Co., Ltd.), UNIDIC 17-806, 17-813, V-4030, and V-4000BA (manufactured by DIC Corporation), EB-1290K, EB-220, EB-5129, EB-1830, and EB-4858 (manufactured by Daicel-UCB Company, Ltd.), A-TMMT, A-TMPT, U-4HA, U-6HA, U-10HA, U-15HA, NK Ester A-9300 (manufactured by SHIN-NAKAMURA CHEMICAL Co., Ltd.), Hi-Cope AU-2010 and AU-2020 (manufactured by TOKUSHIKI Co., Ltd.), ARONIX M-1960 (manufactured by Toagosei Co., Ltd.), and ART RESIN UN-3320HA, UN-3320HC, UN-3320HS, UN-904, and HDP-4T; and polyester compounds having three or more functional groups, such as ARONIX M-8100, M-8030, and M-9050 (manufactured by Toagosei Co., Ltd.) and KRM-8307 (manufactured by Daicel-Cytec Company, Ltd.).

### Metal Thin Wire

As described above, the metal thin wires 35 constitute the first detection electrodes 30 (see FIG. 2) and the second detection electrodes 32 (see FIG. 2).

The metal thin wires 35 are formed of, for example, elemental metal or a laminated body of metals. A method for forming the metal thin wires will be described later.

Examples of the metal contained in the metal thin wires 35 include metals such as gold (Au), silver (Ag), copper (Cu), and aluminum (Al), and alloys thereof. In particular, the metal is preferably silver or copper and more preferably copper because the metal thin wires have excellent conductivity. The metal thin wires are not limited to elemental metal, and may have a multilayer structure. Examples of the structure of the metal thin wires include a structure in which a copper oxynitride layer, a copper layer, and a copper oxynitride layer are sequentially laminated, a structure in which molybdenum (Mo), aluminum (Al), and molybdenum (Mo) are sequentially laminated, and a structure in which molybdenum (Mo), copper (Cu), and molybdenum (Mo) are sequentially laminated.

### Mesh Pattern

The first detection electrodes 30 and the second detection electrodes 32 are constituted by the metal thin wires 35 as described above. For example, the first detection electrodes 30 and the second detection electrodes 32 form a mesh pattern in which the plurality of metal thin wires 35 intersects each other as illustrated in FIG. 4.

In the first detection electrodes and the second detection electrodes, the mesh pattern formed by the metal thin wires 35 preferably has an opening ratio of 90% or more, more preferably 95% or more, from the viewpoint of visible light transmittance. The opening ratio corresponds to a ratio of a light-transmitting portion excluding the metal thin wires in a region provided with the conductive layer, that is, a ratio of opening portions to the entire region provided with the conductive layer.

The first peripheral wiring lines 23a and the second peripheral wiring lines 23b may have the same configuration as the first detection electrodes 30 and the second detection electrodes 32, and may be constituted by the metal thin wires 35. The first peripheral wiring lines 23a and the second peripheral wiring lines 23b may have a mesh pattern in which the plurality of metal thin wires 35 intersects each other.

In the case where the first detection electrodes 30 and the second detection electrodes 32 have a mesh pattern and the first peripheral wiring lines 23a and the second peripheral wiring lines 23b have a mesh pattern, the mesh pattern is not particularly limited. The pattern is preferably a triangle such as an equilateral triangle, an isosceles triangle, or a right triangle; a quadrilateral such as a square, a rectangle, a rhombus, a parallelogram, or a trapezoid; a (regular) n-gon such as a (regular) hexagon or a (regular) octagon; or a geometric figure obtained by combining circles, ellipses, and stars.

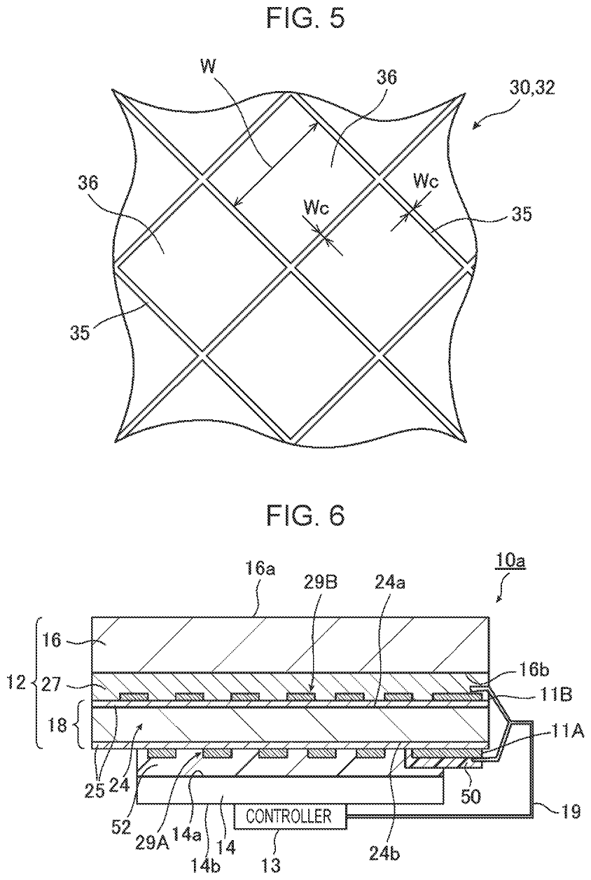

As illustrated in FIG. 5, the mesh of the mesh pattern is intended to be a shape including a plurality of opening portions 36 formed by the metal thin wires 35 that intersect each other. The opening portions 36 are opening regions surrounded by the metal thin wires 35. In FIG. 5, the opening portions 36 have a rhombic shape, but may have another shape. For example, the shape may be a polygonal shape (e.g., a triangular shape, a quadrangular shape, a hexagonal shape, or a random polygonal shape). The shape of one side may be a curved shape or an arc shape instead of a linear shape. In the case of the arc shape, for example, two opposing sides may have an outwardly convex arc shape, and the other two opposing sides may have an inwardly convex arc shape. The shape of each side may be a wavy line shape in which outwardly convex arcs and inwardly convex arcs are continuously arranged. Obviously, the shape of each side may be a sine curve. The mesh pattern is not particularly limited, and may be a random pattern or a regular pattern. The mesh pattern may be a regular mesh pattern in which a plurality of congruent shapes is repeatedly arranged.

The mesh pattern is preferably a regular mesh pattern having the same rhombic lattice. The length of one side of the rhombus, that is, the length W of one side of each opening portion 36 is preferably 50 to 1500 more preferably 150 to 800 and further preferably 200 to 600 μm from the viewpoint of visibility. In the case where the length W of one side of each opening portion 36 is within the above range, good transparency can also be maintained. When the touch panel conductive member 18 (see FIG. 1) is mounted on the display surface 14a (see FIG. 1) of the image display unit 14 (see FIG. 1), the display can be visually recognized without an awkward feeling.

The mesh pattern of the metal thin wires can be observed and measured using an optical microscope (digital microscope VHX-7000 manufactured by Keyence Corporation).

### Method for Forming Metal Thin Wires

The method for forming metal thin wires is not particularly limited. The method for forming metal thin wires that can be appropriately applied is, for example, a plating method, a printing method, or a vapor deposition method.

The method for forming metal thin wires by a plating method will be described. For example, the metal thin wires can be constituted by a metal plating film formed on the undercoat layer by performing electroless plating on the undercoat layer. In this case, a catalyst ink containing at least metal fine particles is formed in a pattern on a base, and then the base is immersed in an electroless plating bath to form a metal plating film. More specifically, a method for producing a metal-coated base described in JP2014-159620A can be used. Alternatively, a resin composition having at least a functional group capable of interacting with a metal catalyst precursor is formed in a pattern on a base, then a catalyst or a catalyst precursor is applied onto the base, and the base is immersed in an electroless plating bath to form a metal plating film. More specifically, a method for producing a metal-coated base described in JP2012-144761A can be applied. The pattern includes a mesh pattern.

The plating method may be only electroless plating or may be electroless plating followed by electrolytic plating. An additive method can be used as the plating method.

The additive method is a method for forming metal thin wires by performing a plating treatment or the like only in a portion of a transparent substrate on which the metal thin wires are to be formed. In view of productivity and the like, the additive method is preferred.

A subtractive method can also be used to form metal thin wires. The subtractive method is a method for forming metal thin wires by forming a conductive layer on a transparent substrate and removing an unnecessary portion by, for example, an etching treatment such as a chemical etching treatment.

The method for forming metal thin wires by a printing method will be described. First, metal thin wires can be formed by applying a conductive paste containing a conductive powder to a substrate in the same pattern as that of the metal thin wires and then performing a heat treatment. The formation of the pattern with the conductive paste is performed by, for example, an inkjet method or a screen printing method. More specifically, the conductive paste that can be used is a conductive paste described in JP2011-28985A.

The method for forming metal thin wires by a vapor deposition method will be described. First, a metal film of copper or the like is formed by vapor deposition. For example, the metal thin wires can be formed in a mesh pattern from the metal film by a photolithography method. As a result, the mesh pattern is constituted by the metal thin wires. The metal film of copper or the like may be an electrolytic copper foil instead of the copper foil layer formed by vapor deposition. More specifically, a process for forming copper wiring lines described in JP2014-29614A can be used.

The method for forming a metal film for forming the metal thin wires may be a publicly known method. Examples of the method include a method using a wet process such as an application method, an inkjet method, a coating method, or a dipping method; a vapor deposition method such as a resistance heating method or an electron beam (EB) method; and a method using a dry process such as a sputtering method or a chemical vapor deposition (CVD) method. Among the above-mentioned film forming methods, the sputtering method is preferably used.

The metal thin wires can be formed in a desired pattern by etching the metal film through a photolithography method.

The photolithography method is a method of processing a metal film into a desired pattern through steps of resist application, formation of a resist film, exposure, development, and rinsing of the resist film, etching of a metal film, and peeling of the resist film. A publicly known typical photolithography method can be appropriately used. For example, the resist may be either a positive resist or a negative resist. After the resist application, pre-heating or pre-baking may be optionally performed. At the time of exposure, a pattern mask having a desired pattern is disposed, and light having a wavelength suitable for the resist used, generally ultraviolet light, is applied from above the pattern mask. After the exposure, development can be performed with a developer suitable for the resist used. Subsequently, the development is stopped using a rinse liquid such as water, and then washing is performed, whereby a resist pattern is formed. The resist pattern is, for example, a pattern corresponding to the mesh pattern.

Next, the formed resist pattern is subjected to pretreatment or post-baking as necessary, and then a pattern corresponding to the resist pattern is formed on the metal film by etching. The etchant can be appropriately selected from those that can be used as an etchant for copper, such as an aqueous ferric chloride solution. After the etching, the remaining resist film is peeled off to obtain metal thin wires having a desired pattern. The photolithography method is a method generally recognized by those skilled in the art, and the specific application mode thereof can be easily selected by those skilled in the art in accordance with the intended purpose.

### Transparent Insulating Layer

The transparent insulating layer 27 is a layer that covers the first metal thin wires, and is transparent and has electrical insulation. The transparent insulating layer 27 is different from the first transparent insulating layer 15 and the second transparent insulating layer 17 described above.

The transparent insulating layer 27 is not particularly limited as long as the transparent insulating layer 27 can maintain electrical insulation without conducting the metal thin wires 35, which are originally in an electrically insulated state, to each other when the touch panel conductive member 18 is used. The transparent insulating layer 27 is formed of, for example, an inorganic material such as silicon dioxide, silicon nitride, silicon oxynitride, or aluminum oxide. Alternatively, the transparent insulating layer 27 is formed of, for example, an organic material such as a (meth)acrylic resin, a urethane resin, or a polyimide resin. The transparent insulating layer 27 is preferably formed of an organic material, particularly preferably a (meth)acrylic resin, from the viewpoint of ease of formation and ease of control of the film thickness.

To form the transparent insulating layer, a transparent insulating layer-forming composition is preferably used as described later.

The transparent insulating layer-forming composition may contain any component, but preferably contains a monomer. The monomer is, for example, a monomer that may be contained in the undercoat layer-forming composition described above. The monomer is preferably a polymerizable compound having a (meth)acryloyl group and more preferably a polyfunctional polymerizable compound having a (meth)acryloyl group (a polymerizable compound having two or more (meth)acryloyl groups).

The transparent insulating layer-forming composition may contain a polymerization initiator and a solvent in addition to the monomer.

The content of the monomer in the transparent insulating layer-forming composition is not particularly limited, but is preferably 40 to 95 mass % relative to the total amount of components excluding the solvent in the transparent insulating layer-forming composition.

The content of the polymerization initiator in the transparent insulating layer-forming composition is not particularly limited, but is preferably 0.1 to 10 mass % relative to the total amount of components excluding the solvent in the transparent insulating layer-forming composition.

### Method for Producing Touch Panel Conductive Member

Hereafter, a method for producing the touch panel conductive member 18 will be described.

The method includes a first step of forming an undercoat layer on a transparent insulating substrate, a second step of forming first metal thin wires on the undercoat layer, and a third step of forming a transparent insulating layer covering the first metal thin wires.

The transparent insulating substrate is, for example, a PET substrate.

In the first step, as illustrated in FIG. 3, an undercoat layer 25 is formed on a front surface 24a of a transparent insulating substrate 24. The undercoat layer 25 includes a surfactant containing at least one of a fluorine atom or a silicon atom as described above. The content of the surfactant is 0.01 to 5 mass % relative to the total mass of the undercoat layer.

It is believed that when the undercoat layer 25 includes a surfactant containing at least one of a fluorine atom or a silicon atom, the surface tension of the undercoat layer 25 is lowered, which lowers the wettability when the transparent insulating layer 27 is formed, whereby voids are easily formed.

The method for forming the undercoat layer 25 is not particularly limited and is, for example, a method in which an undercoat layer-forming composition is applied and a curing treatment is performed as necessary. Examples of the application method include publicly known coating methods such as a spin coating method, a gravure coating method, a reverse coating method, a die coating method, a blade coating method, a roll coating method, an air knife coating method, a screen coating method, a bar coating method, and a curtain coating method.

After the application, a curing treatment may be performed as necessary. Examples of the curing treatment include a photocuring treatment and a heating treatment.

The second step is a step of forming first metal thin wires on a front surface 25a of the undercoat layer 25. The first metal thin wires are formed by the above-described method for forming metal thin wires, and thus the detailed description thereof will be omitted. To form a mesh pattern (see FIG. 4) constituted by the metal thin wires 35, the second step preferably includes a step of forming the first metal thin wires in a mesh pattern (see FIG. 4). The step of forming the first metal thin wires in a mesh pattern is also the same as in the above-described method for forming metal thin wires, and thus the detailed description thereof will be omitted.

The first metal thin wires constitute first detection electrodes 30 (see FIG. 2). The first detection electrodes 30 (see FIG. 2) are formed on the undercoat layer 25.

The third step is a step of forming a transparent insulating layer 27 covering the first metal thin wires. The transparent insulating layer 27 is formed of, for example, a (meth)acrylic resin. As described above, the thickness of the transparent insulating layer 27 is preferably 1.0 to 5.0 μm.

The method for forming the transparent insulating layer 27 is not particularly limited. The method is, for example, a method for forming a transparent insulating layer (coating method) or a method for forming a transparent insulating layer on a temporary substrate and transferring the transparent insulating layer onto the front surface 25a of the undercoat layer 25 so as to cover the metal thin wires (transfer method).

The third step is preferably a step of applying a transparent insulating layer-forming composition onto the first metal thin wires to form a transparent insulating layer 27. That is, the transparent insulating layer 27 is preferably formed by using a coating method from the viewpoint of ease of control of the thickness.

The method for applying the transparent insulating layer-forming composition is not particularly limited and may be, for example, a publicly known method, e.g., a coating method using a gravure coater, a comma coater, a bar coater, a knife coater, a die coater, or a roll coater, an inkjet method, or a screen printing method.

After the application, a curing treatment may be performed as necessary. Examples of the curing treatment include a photocuring treatment and a heating treatment.

Depending on the configuration of the touch panel conductive member, the method may further include a fourth step of forming second metal thin wires on the transparent insulating layer 27.

Since the second metal thin wires in the fourth step are formed by the above-described method for forming metal thin wires, the detailed description thereof will be omitted. To form a mesh pattern (see FIG. 4) constituted by the metal thin wires 35, the second metal thin wires may also be formed in a mesh pattern (see FIG. 4) in the fourth step. The second metal thin wires constitute second detection electrodes 32 (see FIG. 2). The second detection electrodes are formed on the transparent insulating layer 27. In the fourth step, second peripheral wiring lines 23b electrically connected to the second detection electrodes 32 are also formed by the second metal thin wires.

A second transparent insulating layer 17 may be formed on the second detection electrodes 32 and the second peripheral wiring lines 23b. The second transparent insulating layer 17 is formed of, for example, an optical clear adhesive (OCA) and has flexibility. Since the second transparent insulating layer 17 has flexibility, it is not necessary to dispose the above-described voids 37 (see FIG. 3) of the metal thin wires 35 in the second metal thin wires. A shield electrode may be disposed on the second transparent insulating layer 17.

### Another Example of Image Display Device

The image display device is not limited to the image display device 10 illustrated in FIG. 1. Hereafter, another example of the image display device 10 will be described.

FIG. 6 is a schematic sectional view illustrating a second example of an image display device having a touch panel conductive member according to an embodiment of the present invention. In FIG. 6, the same components as those illustrated in FIGS. 1 to 3 are denoted by the same reference numerals, and the detailed description thereof will be omitted.

An image display device 10a of the second example illustrated in FIG. 6 is different from the image display device 10 illustrated in FIG. 1 in that the first detection electrodes 29A and the second detection electrodes 29B are disposed on both surfaces of the transparent insulating substrate 24. The undercoat layer 25 is disposed on each of the front surface 24a and the rear surface 24b of the transparent insulating substrate 24. The second detection electrode layer 29B is disposed on the undercoat layer 25 on the front surface 24a side. The first detection electrode layer 29A is disposed on the undercoat layer 25 on the rear surface 24b side. The first detection electrode layer 29A and the second detection electrode layer 29B are electrically insulated from each other by the transparent insulating substrate 24. That is, the first detection electrodes 30 and the second detection electrodes 32 are electrically insulated from each other by the transparent insulating substrate 24.

In the image display device 10a, a transparent insulating layer 52 is disposed so as to cover the first detection electrode layer 29A and a peripheral wiring insulating layer 50 on the first peripheral wiring lines 23a. The transparent insulating layer 27 covering the second detection electrode layer 29B is disposed on the undercoat layer 25 on the front surface 24a side of the transparent insulating substrate 24. The cover layer 16 is disposed on the transparent insulating layer 27. The image display unit 14 is connected to the transparent insulating layer 52 with the display surface 14a facing the transparent insulating layer 52. The transparent insulating layer 52 has the same configuration as the transparent insulating layer 27. The first metal thin wires constituting the first detection electrode layer 29A and the second metal thin wires constituting the second detection electrode layer 29B have the same configuration as the metal thin wires 35 illustrated in FIG. 3. As described above, the void 37 can be disposed at six or more positions among 20 of the side surfaces 35b in total when the sections of ten metal thin wires 35 are observed.

The peripheral wiring insulating layer 50 is formed on the first peripheral wiring lines 23a for the purpose of preventing the migration and corrosion of lead-out wiring lines. The peripheral wiring insulating layer 50 is, for example, an organic film formed of a (meth)acrylic resin, a urethane resin, or the like. The thickness of the peripheral wiring insulating layer 50 is preferably 1 to 30 μm.

The present invention basically has the above configuration. The touch panel conductive member and the method for producing a touch panel conductive member according to the present invention have been described in detail, but the present invention is not limited to the above-described embodiments. Various improvements or modifications may be obviously made without departing from the spirit of the present invention.

### EXAMPLES

Hereafter, the features of the present invention will be further specifically described based on Examples. Materials, reagents, amounts and percentages of substances, operations, and the like used in Examples below can be appropriately changed without departing from the spirit of the present invention. Therefore, the scope of the present invention is not limited to Examples below.

Hereafter, touch panel conductive members in Examples 1 to 12 and Comparative Examples 1 to 5 will be described. Example 1

A touch panel conductive member in Example 1 will be described.

First, a PET film (COSMOSHINE A4300, manufactured by TOYOBO Co., Ltd.) having a thickness of 50 μm and having both surfaces on which an easily adhesive layer was formed was prepared as a transparent insulating substrate.

### Formation of Undercoat Layer

UCL1 shown in Table 1 below was applied onto both surfaces of the PET film as an undercoat layer-forming composition by a spin coating method so as to have a dry thickness of 1.5 Subsequently, the PET film was irradiated with ultraviolet rays having a light intensity of 400 mJ using an ultraviolet irradiation apparatus (120 W high-pressure mercury lamp manufactured by Eye Graphics Co., Ltd.) to cure UCL1, thereby preparing an undercoat layer (UC1).

### Formation of Copper Film

Next, a copper oxide film was formed as an adhesion layer on one surface of the above undercoat layer (UC1). The copper oxide film was formed by performing sputtering using copper as a target at an in-chamber pressure of 0.4 Pa, a power density of 1.7 W/cm², and a film-formation temperature of 90° C. while introducing a mixture gas of oxygen gas (flow rate 90 sccm (standard cubic centimeter per minute)) and argon gas (flow rate 270 sccm) into an sputtering apparatus. The thickness of the obtained copper oxide film was 20 nm.

Note that 90 sccm is 152.1×10⁻³ Pa·m³/sec, and 270 sccm is 456.3×10⁻³ Pa·m³/sec.

Subsequently, a copper film was formed on the formed copper oxide film. The copper film was formed by performing sputtering using copper as a target at an in-chamber pressure of 0.4 Pa, a power density of 4.2 W/cm², and a film-formation temperature of 90° C. while introducing argon gas (flow rate 270 sccm (456.3×10⁻³ Pa·m³/sec)) into the sputtering apparatus. In the thus-obtained laminated body, the thickness of the copper film was 350 nm. Patterning of metal thin wires

After the copper film was formed, a rustproof treatment was performed on the copper film, and the copper film was patterned by a photolithography method. At this time, a positive resist was applied onto the copper film so as to have a thickness of 2 μm, thereby forming a resist film. Then, a glass photomask having a regular mesh pattern (MP1) with a line width of 5.0 μm in which rhombuses each having a side of 600 μm and an acute angle of 65° were continuously arranged was prepared.

The copper film was irradiated with light from a metal halide lamp while the glass photomask was disposed on the resist film. Then, the laminated body on which the resist film was disposed was developed by being immersed in a 3% aqueous sodium hydroxide solution to obtain a resist film having a pattern corresponding to the mesh pattern (MP1). Using the patterned resist film as a mask, the copper oxide film and the copper film were simultaneously etched with a 5% aqueous ferric chloride solution to pattern metal thin wires. Finally, the remaining resist film was peeled off to obtain first metal thin wires arranged in a mesh pattern (MP1).

Subsequently, a transparent insulating layer-forming composition was applied so as to cover the first metal thin wires to form a transparent insulating layer formed of an acrylic resin and having a thickness of 3.0 μm.

The transparent insulating layer-forming composition contained 97 mass % of NK Ester A-9300 manufactured by SHIN-NAKAMURA CHEMICAL Co., Ltd. and 3 mass % of Irgacure 907 manufactured by IGM Resins B.V.

Then, a copper film having a thickness of 350 nm was formed on the transparent insulating layer as described above. Then, second metal thin wires having a mesh pattern (MP2) were formed in the same procedure as the first metal thin wires arranged in the mesh pattern (MP1). Thus, a touch panel conductive member was obtained.

The mesh pattern MP1 and the mesh pattern MP2 were arranged such that the rhombic lattices were shifted from each other by 300 μm, and the vertexes of the rhombuses of the mesh pattern MP2 were located at the intersection points of the diagonal lines of the rhombic lattices of the mesh pattern MP1.

In Example 1, sections of ten metal thin wires were observed using a scanning electron microscope (SEM) to determine whether or not voids were present at each side surface, that is, at 20 side surfaces in total. In Example 1, the void percentage was 40%. That is, voids were present at 8 side surfaces among the 20 side surfaces.

The void percentage is a ratio calculated from the number of voids present at the 20 side surfaces.

Table 2 below shows the void percentage and the number of voids.

The voids were judged based on the following criteria.

### Criteria

The size judged to be a void is set to a size of 50% or more of the height of the metal thin wires.

The voids are present at the interface of the metal thin wires on the transparent insulating substrate side.

The void refers to a void in contact with the undercoat layer and the side surface of the metal thin wire, and does not refer to a specific shape.

### Example 2

Example 2 was the same as Example 1 except that the metal thin wires had a thickness of 600 nm and the void percentage was 50%. In Example 2, voids were present at 10 side surfaces among 20 side surfaces.

### Example 3

Example 3 was the same as Example 1 except that the metal thin wires had a width of 1.5 μm and a thickness of 600 nm, and the void percentage was 55%. In Example 3, voids were present at 11 side surfaces among 20 side surfaces.

### Example 4

Example 4 was the same as Example 1 except that the metal thin wires had a width of 1.5 μm and a thickness of 900 nm, and the void percentage was 60%. In Example 4, voids were present at 12 side surfaces among 20 side surfaces.

### Example 5

Example 5 was the same as Example 1 except that the undercoat layer-forming composition was UCL2 in Table 1 below, the content of the surfactant in the undercoat layer was 1.50 mass %, the metal thin wires had a width of 3.0 μm and a thickness of 600 nm, and the void percentage was 60%. In Example 5, voids were present at 12 side surfaces among 20 side surfaces.

### Example 6

Example 6 was the same as Example 1 except that the undercoat layer-forming composition was UCL2 in Table 1 below, the content of the surfactant in the undercoat layer was 1.50 mass %, the metal thin wires had a width of 1.5 μm and a thickness of 600 nm, and the void percentage was 70%. In Example 6, voids were present at 14 side surfaces among 20 side surfaces.

### Example 7

Example 7 was the same as Example 1 except that the undercoat layer-forming composition was UCL2 in Table 1 below, the content of the surfactant in the undercoat layer was 1.50 mass %, the metal thin wires had a width of 1.5 μm and a thickness of 900 nm, and the void percentage was 70%. In Example 7, voids were present at 14 side surfaces among 20 side surfaces.

### Example 8

Example 8 was the same as Example 1 except that the undercoat layer-forming composition was UCL3 in Table 1 below, the content of the surfactant in the undercoat layer was 0.04 mass %, the metal thin wires had a width of 3.0 μm, and the void percentage was 30%. In Example 8, voids were present at 6 side surfaces among 20 side surfaces.

### Example 9

Example 9 was the same as Example 1 except that the undercoat layer-forming composition was UCL3 in Table 1 below, the content of the surfactant in the undercoat layer was 0.04 mass %, the metal thin wires had a width of 3.0 μm and a thickness of 600 nm, and the void percentage was 35%. In Example 9, voids were present at 7 side surfaces among 20 side surfaces.

### Example 10

Example 10 was the same as Example 1 except that the undercoat layer-forming composition was UCL5 in Table 1 below, the content of the surfactant in the undercoat layer was 4.02 mass %, the metal thin wires had a width of 1.5 μm and a thickness of 600 nm, and the void percentage was 80%. In Example 10, voids were present at 16 side surfaces among 20 side surfaces.

### Example 11

Example 11 was the same as Example 1 except that the metal thin wires had a width of 1.0 μm and a thickness of 600 nm, and the void percentage was 50%. In Example 11, voids were present at 10 side surfaces among 20 side surfaces.

### Example 12

Example 12 was the same as Example 1 except that the metal thin wires had a width of 1.0 μm and a thickness of 600 nm, and the void percentage was 50%. In Example 12, voids were present at 10 side surfaces among 20 side surfaces.

### Comparative Example 1

Comparative Example 1 was the same as Example 1 except that the undercoat layer-forming composition was UCL4 in Table 1 below, the content of the surfactant in the undercoat layer was 0.0 mass %, the metal thin wires had a width of 5.0 μm, and the void percentage was 5%. In Comparative Example 1, voids were present at 1 side surface among 20 side surfaces.

### Comparative Example 2

Comparative Example 2 was the same as Example 1 except that the undercoat layer-forming composition was UCL4 in Table 1 below, the content of the surfactant in the undercoat layer was 0.0 mass %, the metal thin wires had a width of 3.0 μm, and the void percentage was 0%. In Comparative Example 2, no void was present.

### Comparative Example 3

Comparative Example 3 was the same as Example 1 except that the undercoat layer-forming composition was UCL4 in Table 1 below, the content of the surfactant in the undercoat layer was 0.0 mass %, the metal thin wires had a width of 4.0 μm and a thickness of 600 nm, and the void percentage was 15%. In Comparative Example 3, voids were present at 3 side surfaces among 20 side surfaces.

### Comparative Example 4

Comparative Example 4 was the same as Example 1 except that the undercoat layer-forming composition was UCL4 in Table 1 below, the content of the surfactant in the undercoat layer was 0.0 mass %, the metal thin wires had a width of 1.5 μm and a thickness of 250 nm, and the void percentage was 0%. In Comparative Example 4, no void was present.

### Comparative Example 5

Comparative Example 5 was the same as Example 1 except that the undercoat layer-forming composition was UCL2 in Table 1 below, the content of the surfactant in the undercoat layer was 1.50 mass %, the metal thin wires had a width of 3.0 μm and a thickness of 1100 nm, and the void percentage was 65%. In Comparative Example 5, voids were present at 13 side surfaces among 20 side surfaces.

TABLE 1

| | | UCL1 | UCL2 | UCL3 | UCL4 | UCL5 |
|---|---|---|---|---|---|---|
| Urethane | parts | 100 | 100 | 100 | 100 | 100 |
| acrylate | by mass | | | | | |
| Photopolymeri- | parts | 5 | 5 | 5 | 5 | 5 |
| zation initiator | by mass | | | | | |
| Surfactant | parts | 1 | 4 | 0.1 | 0 | 11 |
| | by mass | | | | | |
| MIBK | parts | 397 | 397 | 397 | 397 | 397 |
| | by mass | | | | | |

In Table 1, the urethane acrylate is a SHIKOH UV7600B with a solid content of 100 mass % manufactured by Mitsubishi Chemical Corporation.

The photopolymerization initiator is an IRGACURE 907 with a solid component of 100 mass % manufactured by IGM Resins B.V.

The surfactant is a MEGAFACE RS-56 with a solid content of 40 mass % manufactured by DIC Corporation.

MIBK refers to methyl isobutyl ketone.

The content of the surfactant refers to an amount based on solid content and can be calculated as follows.

For UCL1, the undercoat layer (solid content) is 100+5+(1×0.4)=105.4.

The surfactant (solid content) is 1×0.4=0.4.

The content of the surfactant in UCL1 is (0.4/105.4)×100=0.38 mass %.

Similarly, for UCL2, the undercoat layer (solid content) is 100+5+(4×0.4)=106.6.

The surfactant (solid content) is 4×0.4=1.6.

The content of the surfactant in UCL2 is (1.6/106.6)×100=1.50 mass %.

For UCL3, the undercoat layer (solid content) is 100+5+(0.1×0.4)=105.04.

The surfactant (solid content) is 0.1×0.4=0.04.

The content of the surfactant in UCL3 is (0.04/105.04)×100=0.04 mass %.

For UCL4, the surfactant is not contained.

For UCL5, the undercoat layer (solid content) is 100+5+(11×0.4)=109.4.

The surfactant (solid content) is 11×0.4=4.4.

The content of the surfactant in UCL5 is (4.4/109.4)×100=4.02 mass %.

In Examples, the touch panel conductive members in Examples 1 to 12 and Comparative Examples 1 to 5 were evaluated for bendability, thin wire resistance, and visibility. Table 2 below shows the evaluation results of bendability, thin wire resistance, and visibility. Hereafter, the bendability, the thin wire resistance, and the visibility will be described.

### Bendability

For the bending test, a compact desktop test machine TCDM111LH manufactured by YUASA SYSTEM Co., Ltd. was used. The touch panel conductive member was bent five times with a bending diameter of 5 mm.

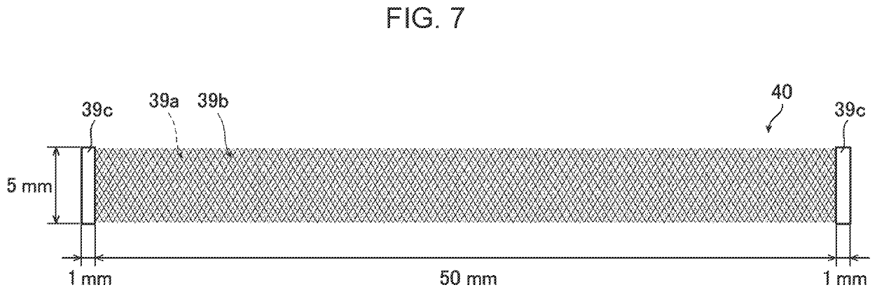

For the evaluation of bendability, a sample was used in which lead-out electrodes 39c (see FIG. 7) having a length of 5 mm and a width of 1 mm and electrically connected to first metal thin wires 39a were formed at both ends of the short sides in a mesh pattern region that had a length of 5 mm and a width of 50 mm and that were constituted by rhombuses with one side of 600 μm surrounded by the first metal thin wires 39a (see FIG. 7). A transparent insulating film (not illustrated) was formed so as not to cover the lead-out electrodes 39c. A mesh pattern that had a length of 5 mm and a width of 48 mm and that was constituted by rhombuses with one side of 600 μm surrounded by second metal thin wires 39b (see FIG. 7) was formed on the transparent insulating film so as to be shifted by 300 μm with respect to the rhombic lattices formed by the first metal thin wires 39a. Thus, a touch panel conductive member 40 for evaluating bendability (see FIG. 7) was produced.

Herein, the first metal thin wires 39a having a mesh pattern illustrated in FIG. 7 are disposed below the second metal thin wires 39b having a mesh pattern.

For bending, mountain-folding was performed by 180° at the central portion of the long side of the mesh pattern region so that the second metal thin wires having a mesh pattern were located outside with respect to the first metal thin wires 39a having a mesh pattern and illustrated in FIG. 7. Upon bending, the second metal thin wires 39b having a mesh pattern are located outside.

For the touch panel conductive member for evaluating bendability, the electrical resistance between the lead-out electrodes at both ends of the mesh pattern region was measured before and after the bending to determine a percentage change in electrical resistance before and after the bending. The electrical resistance was measured with an ohmmeter (RM3544 manufactured by HIOKI E.E. Corporation). Based on the obtained percentage change in resistance, the bendability was evaluated according to the following evaluation criteria A to C.

A: The percentage change in resistance is less than 10%.
B: The percentage change in resistance is 10% or more and less than 20%.
C: The percentage change in resistance is 20% or more.

### Thin Wire Resistance

After formation of the first metal thin wires and before formation of the transparent insulating layer, the electrical resistance of the first metal thin wires was measured and normalized to an electrical resistance per 1 mm length (Ω/mm). This was performed for ten first metal thin wires (one side constituting the mesh cell), and the average value of the ten first metal thin wires was defined as the thin wire resistance. The electrical resistance of the first metal thin wires was measured using an ohmmeter (RM3544 manufactured by HIOKI E.E. Corporation).

### Visibility

The touch panel conductive member was mounted on a liquid crystal display module equipped with a liquid crystal display and a controller for controlling the display of an image on the liquid crystal display. Subsequently, evaluators for visibility observed the touch panel conductive member mounted on the liquid crystal display module while the entire screen of the liquid crystal display in the liquid crystal display module was turned on in green. The visibility was evaluated based on whether or not moire was visually recognized. The visibility was evaluated by 20 evaluators. The evaluators evaluated the visibility based on the following evaluation criteria A to D.

A: None of the evaluators out of twenty recognized moire.
B: One or more and three or less out of twenty evaluators recognized moire.
C: Four or more and nine or less out of twenty evaluators recognized moire.
D: Ten or more out of twenty evaluators recognized moire.

The evaluation “D” is a level at which there is a practical problem. The evaluation “C” or higher is a level at which there is no practical problem. The evaluation “B” is a better level, and the evaluation “A” is an excellent level.

TABLE 2

| | | Content of | | | | | | | |
|---|---|---|---|---|---|---|---|---|---|
| | Undercoat | surfactant | Width | Thickness | | | | | |
| | layer- | in undercoat | of metal | of metal | | Void | | | |
| | forming | layer | thin wire | thin wire | Number | percentage | | Thin wire | |
| | composition | (mass %) | (μm) | (μm) | of voids | (%) | Bendability | resistance | Visibility |
| Example 1 | UCL1 | 0.38 | 4.0 | 350 | 8 | 40 | A | 25 | C |
| Example 2 | UCL1 | 0.38 | 4.0 | 600 | 10 | 50 | A | 14 | C |
| Example 3 | UCL1 | 0.38 | 1.5 | 600 | 11 | 55 | A | 39 | A |
| Example 4 | UCL1 | 0.38 | 1.5 | 900 | 12 | 60 | A | 26 | A |
| Example 5 | UCL2 | 1.50 | 3.0 | 600 | 12 | 60 | A | 20 | B |
| Example 6 | UCL2 | 1.50 | 1.5 | 600 | 14 | 70 | A | 39 | A |
| Example 7 | UCL2 | 1.50 | 1.5 | 900 | 14 | 70 | A | 26 | A |
| Example 8 | UCL3 | 0.04 | 3.0 | 350 | 6 | 30 | B | 33 | B |
| Example 9 | UCL3 | 0.04 | 3.0 | 600 | 7 | 35 | B | 20 | B |
| Example 10 | UCL5 | 4.02 | 1.5 | 600 | 16 | 80 | A | 39 | A |
| Example 11 | UCL1 | 0.38 | 5.0 | 600 | 10 | 50 | A | 12 | C |
| Example 12 | UCL1 | 0.38 | 1.0 | 600 | 10 | 50 | A | 59 | A |
| Comparative | UCL4 | 0.0 | 5.0 | 350 | 1 | 5 | C | 20 | D |
| Example 1 | | | | | | | | | |
| Comparative | UCL4 | 0.0 | 3.0 | 350 | 0 | 0 | C | 33 | B |
| Example 2 | | | | | | | | | |
| Comparative | UCL4 | 0.0 | 4.0 | 600 | 3 | 15 | C | 15 | C |
| Example 3 | | | | | | | | | |
| Comparative | UCL4 | 0.0 | 1.5 | 250 | 0 | 0 | A | 94 | A |
| Example 4 | | | | | | | | | |
| Comparative | UCL2 | 1.50 | 3.0 | 1100 | 13 | 65 | C | 11 | B |
| Example 5 | | | | | | | | | |

As shown in Table 2, Examples 1 to 12 were better than Comparative Examples 1 to 5 in terms of the evaluation of bendability and thin wire resistance, and both low resistance and good bendability could be achieved.

In Comparative Examples 1 to 3, the void percentage was small, and thus the bendability was poor. In Comparative Example 4, the thickness of the metal thin wires was small, and thus the thin wire resistance was large. In Comparative Example 5, the thickness of the metal thin wires was large, and thus the bendability was poor.

From the comparison between Examples 1 and 2 and Examples 5, 8, 9, and the like, it is understood that when the metal thin wires have the same wire width, the wire resistance of the touch panel conductive member decreases as the thickness of the metal thin wires increases.

From the comparison between Examples 1 to 4, it is understood that the void percentage of the touch panel conductive member increases as the thickness of the metal thin wires increases. From the comparison between Examples 5 to 7, it is understood that the void percentage of the touch panel conductive member increases as the wire width of the metal thin wires decreases. From the comparison between Examples 1 to 12, it is understood that the void percentage of the touch panel conductive member increases as the content of the surfactant increases, and the visibility of the touch panel conductive member improves as the metal thin wires becomes thin.

### REFERENCE SIGNS LIST

10a image display device
11A first conductive layer
11B second conductive layer
12 touch panel
13 controller
14 image display unit
14a display surface
14b, 16b, 24b rear surface
15 first transparent insulating layer
16 cover layer
16a, 24a, 25a, 27a, 35a front surface
17 second transparent insulating layer
18 touch panel conductive member
19 flexible circuit board
20 detection portion
22 peripheral wiring portion
23a first peripheral wiring line
23b second peripheral wiring line
24 transparent insulating substrate
25 undercoat layer
26a first external connection terminal
26b second external connection terminal
27 transparent insulating layer
29A first detection electrode layer
29B second detection electrode layer
30 first detection electrode
31a first dummy electrode
31b second dummy electrode
32 second detection electrode
33 first electrode terminal
34 second electrode terminal
35 metal thin wire
35b side surface
36 opening portion
37 void
38 blackened layer
39a first metal thin wire
39b second metal thin wire
39c lead-out electrode
40 touch panel conductive member for evaluating bendability
50 peripheral wiring insulating layer
52 transparent insulating layer
Bf bending region
E₁ detection region
E₂ peripheral region
ta, tc thickness

What is claimed is:

1. A touch panel conductive member comprising:
a transparent insulating substrate;
an undercoat layer disposed on the transparent insulating substrate;
first metal thin wires disposed on the undercoat layer; and
a transparent insulating layer covering the first metal thin wires,
wherein the first metal thin wires have a thickness of 350 to 1000 nm, and
when a sectional image of the touch panel conductive member in a direction orthogonal to a direction in which the first metal thin wires extend is taken at ten positions and one of the first metal thin wires is observed at each of the ten positions, a void between a side surface of the one of the first metal thin wires and the transparent insulating layer is observed at six or more positions.

2. The touch panel conductive member according to claim 1,
wherein the first metal thin wires constitute a mesh pattern, and have a width of 1.5 to 4.0 μm.

3. The touch panel conductive member according to claim 1,
wherein second metal thin wires are further disposed on the transparent insulating layer, and the transparent insulating layer has a thickness of 1.0 to 5.0 μm.

4. The touch panel conductive member according to claim 3,
wherein the second metal thin wires constitute a mesh pattern, and have a width of 1.5 to 4.0 μm.

5. The touch panel conductive member according to claim 1,
wherein the first metal thin wires are formed of copper.

6. The touch panel conductive member according to claim 3,
wherein the second metal thin wires are formed of copper.

7. The touch panel conductive member according to claim 1,
wherein the transparent insulating substrate is a substrate including a polyester resin, and has a thickness of 10 to 60 μm.

8. A method for producing a touch panel conductive member, comprising:
a first step of forming an undercoat layer on a transparent insulating substrate;
a second step of forming first metal thin wires on the undercoat layer; and
a third step of forming a transparent insulating layer covering the first metal thin wires,
wherein the first metal thin wires have a thickness of 350 to 1000 nm, and
the undercoat layer includes a surfactant containing at least one of a fluorine atom or a silicon atom, and a content of the surfactant is 0.01 to 5 mass % relative to a total mass of the undercoat layer.

9. The method for producing a touch panel conductive member according to claim 8,
wherein the third step is a step of applying a transparent insulating layer-forming composition onto the first metal thin wires to form the transparent insulating layer.

10. The method for producing a touch panel conductive member according to claim 8,
wherein the second step includes a step of forming the first metal thin wires in a mesh pattern.

11. The method for producing a touch panel conductive member according to claim 8, the method further comprising:
a fourth step of forming second metal thin wires on the transparent insulating layer.

12. The method for producing a touch panel conductive member according to claim 11,
wherein the fourth step includes a step of forming the second metal thin wires in a mesh pattern.

13. The method for producing a touch panel conductive member according to claim 8,
wherein the first metal thin wires are formed of copper.

14. The method for producing a touch panel conductive member according to claim 11,
wherein the second metal thin wires are formed of copper.

15. The touch panel conductive member according to claim 2,
wherein second metal thin wires are further disposed on the transparent insulating layer, and the transparent insulating layer has a thickness of 1.0 to 5.0 μm.

16. The touch panel conductive member according to claim 15,
wherein the second metal thin wires constitute a mesh pattern, and have a width of 1.5 to 4.0 μm.

17. The touch panel conductive member according to claim 2,
wherein the first metal thin wires are formed of copper.

18. The touch panel conductive member according to claim 4,
wherein the second metal thin wires are formed of copper.

19. The touch panel conductive member according to claim 2,
wherein the transparent insulating substrate is a substrate including a polyester resin, and has a thickness of 10 to 60 μm.

20. The method for producing a touch panel conductive member according to claim 9,
wherein the second step includes a step of forming the first metal thin wires in a mesh pattern.
